(19) United States
(12) Patent Application Publication
(10) Pub. No.: US 2007/0160819 A1
(43) Pub. Date: Jul. 12, 2007

(54) Lead sheet materials

(75) Inventor: David Taylor, Dunfermline (GB)

Correspondence Address: EDWARDS ANGELL PALMER & DODGE LLP, P.O. BOX 55874, BOSTON, MA, 02205, US

(73) Assignee: ENVIROFIX LIMTED, CHARLESTOWN UNITED KINGDOM (GB)

(21) Appl. No.: 10/561,412

(22) PCT Filed: Jun. 21, 2004
(86) PCT No.: PCT/GB04/02661

§ 371 Date: Feb. 20, 2007

(30) Foreign Application Priority Data
Jun. 19, 2003 (GB) 0314484.7

(51) Int. Cl. C08F 2/46; B05D 7/00; B05D 1/28; B05D 1/18; B32B 27/38; B32B 15/04; B32B 15/08

(52) U.S. Cl. 428/217; 427/487; 427/430.1; 427/421.1; 427/429; 428/457; 428/418; 428/463; 428/422; 428/334

(57) ABSTRACT

A leach-Preventative coating for a lead sheet material such as a flashing or roof covering is disclosed. The coating layer is a UV-curved non-brittle solid film and may include a solid film lubricant such as polytetrafluoroethylene (PTFE). In one embodiment, the coating layer includes and abhorrent material for repelling pests.

The present invention relates to a sealant for lead materials and articles, and in particular to a sealant for lead materials used in the construction industry, such as a flashing material or roof covering comprising a lead layer. The invention also relates to lead materials and articles to which the sealant is applied.

Flashing materials are used in the construction industry to protect the building or structure from moisture penetration. Flashing materials are often provided between building components or over joins and seams to divert water flow. Typically, flashing materials are used around windows, doors and openings and on roofing valleys and ridges. Flashings also appear between buildings as gutters, and in many cases form the beds of wide guttering channels.

Flashings generally comprise sheet materials, which may be cut and formed into the required shape in situ. Pre-formed flashings are also produced in standard shapes for use in areas with known dimensions. The flashing will however require working and forming around and into the area to which it is fitted, and is therefore required to be pliable, malleable and of sufficient thickness to prevent any cracks or defects produced during the forming process from impairing the waterproofing effect. Similar sheet materials, although generally larger in scale, are used for roof coverings themselves, typically on flat or low-pitch roofs.

Lead is traditionally used for flashing and roofing materials due to its deformability, resistance to damage, and relative longevity. In order to provide the lead with further protection, coatings have been suggested for the covering exposed surfaces of the lead. Particular problems with the use of lead include tarnishing of the lead and other nearby surfaces, and the toxicity of the lead and its alloys giving rise to an environmental and ecological risk in its use. Run-off from lead itself or its oxides can ultimately result in the erosion of the lead sheet to an inadequate thickness. Each of the above drawbacks is exacerbated by the prevalence of acid rain in many areas.

U.S. Pat. No. 4,966,819 and EP 0038222 disclose lead materials provided with aluminium layers for providing environmental protection and improved aesthetic effects. The use of an aluminium layer significantly increases the cost of the materials and significantly increases the manufacturing costs of the flashing material. Furthermore, the aluminium foils cannot be applied retroactively to lead flashings in situ, and additional coating materials such as lacquers, paints or anodisation are often required to prevent corrosion of the aluminium.

It would therefore be desirable to obviate or at least mitigate some of the drawbacks associated with the prior art.

It is therefore an object of one aspect of the invention to provide a cost efficient coating for a lead sheet material.

It is a further object of an aspect of the invention to provide a coating for a lead sheet material that may be applied retroactively.

Other aims and objects of the invention will become apparent from a reading of the following description.

According to a first aspect of the present invention there is provided sheet material comprising a lead layer and a leach-preventative coating, wherein the leach-preventative coating comprises an ultra-violet (UV) cured non-brittle solid film layer.

The leach-preventative coating may comprise an acrylic based polymer.

The leach-preventative coating may comprise an epoxy based polymer.

The leach-preventative coating may comprise a mixture of an acrylic based polymer and an epoxy based polymer.

Preferably, the leach-preventative coating comprises a material having a softness greater than that of lead.

The leach-preventative coating may comprise polytetrafluoroethylene (PTFE).

The leach-preventative coating may comprise molybdenum disulphide.

PTFE or molybdenum disulphide may be present in 0.1% to 2% dry weight on dry polymer.

The leach-preventative coating may have a thickness of up to 300 microns.

The leach-preventative coating further comprises a photoinitiator for the initiation of a radical chain reaction.

The photoinitiator may be of the cationic photoinitiator type such as but not limited to; diazonium salts, diaryliodium salts, triarylsulphonium salts, ferrocenium salts, dialkylphenacylsulphonium salts, sulphonyloxyketones or silylbenzylethers.

The photoinitiator may be of the radical photoinitiator type such as but not limited to; alkylarylketones (acetophenone, benzophenone and derivatives thereof), diarylketones, benzoine, benzoine ethers, benzoineketals, benzilketals, acylphosphine oxide, thioxanthones and titanocenes.

The leach-preventative coating may further comprise an abhorrent material for deterring pests from attacking said leach-preventative coating.

The abhorrent material may include chilli or chilli pepper. The abhorrent material may include extract of habanero pepper.

According to a second aspect of the present invention there is provided a roofing material comprising the sheet material of the first aspect.

According to a third aspect of the present invention there is provided a flashing comprising the sheet material of the first aspect.

According to a fourth aspect of the present invention there is provided a leach-preventative coating for a sheet material having a lead layer, wherein the leach-preventative coating comprises a non-brittle solid film layer.

The leach-preventative coating may comprise a material having a softness greater than that of lead.

The leach-preventative coating may comprise an acrylic based polymer.

The leach-preventative coating may comprise an epoxy based polymer.

The leach-preventative layer may comprise a mixture of an acrylic based polymer and an epoxy based polymer.

The leach-preventative coating may comprise a solid film lubricant.

The leach-preventative coating may comprise polytetrafluoroethylene (PTFE).

The leach-preventative may comprise molybdenum disulphide.

PTFE or molybdenum disulphide may be present in 0.1% to 2% dry weight on dry polymer.

The leach-preventative coating may have a thickness of up to 300 microns.

The leach-preventative coating may comprise an abhorrent material for deterring pests from attacking said leach-preventative coating.

The abhorrent material may include chilli or chilli pepper.

The abhorrent material may include extract of habanero pepper.

According to a fifth aspect of the present invention there is provided a method of preventing leaching of a flashing material having a lead layer, the method comprising the steps of applying an ultra-violet curable coating having a non-brittle solid film layer to a lead base layer, and UV curing the applied coating.

The coating may comprise a polymer.

The coating may comprise a solid film lubricant layer.

The coating may be applied by a dipping process.

The coating may be applied by a spraying process.

The coating may be applied by a barrel process.

The coating may be applied by a brushing process.

The UV light may be supplied by any suitable light source including sunlight or any suitable lamp.

The lamp may be a mercury arc lamp.

The UV light may be supplied by a source restricted to wavelengths between 200 nanometres and 320 nanometres.

The lead base layer may be part of a construction or building.

According to a sixth aspect of the present invention there is provided a sheet material comprising a lead layer and a leach-preventative coating, wherein the leach-preventative coating comprises a solid film layer and an abhorrent material for deterring pests from attacking said leach-preventative coating.

According to a seventh aspect of the present invention there is provided a leach-preventative coating for a sheet material having a lead layer, wherein the leach-preventative coating comprises a solid film layer and an abhorrent material for deterring pests from attacking said leach-preventative coating.

According to a eighth aspect of the present invention there is provided a method of preventing leaching of a flashing material having a lead layer, the method comprising the step of applying a coating to a lead base layer, the coating having a solid film layer and an abhorrent material for deterring pests from attacking said leach-preventative coating.

According to a ninth aspect of the present invention there is provided a sheet material comprising a lead layer and a leach-preventative coating, wherein the leach-preventative coating comprises a UV cured non-brittle polymer layer.

An embodiment of the present invention will now be described, by way of example only, with reference to the following drawings, of which:

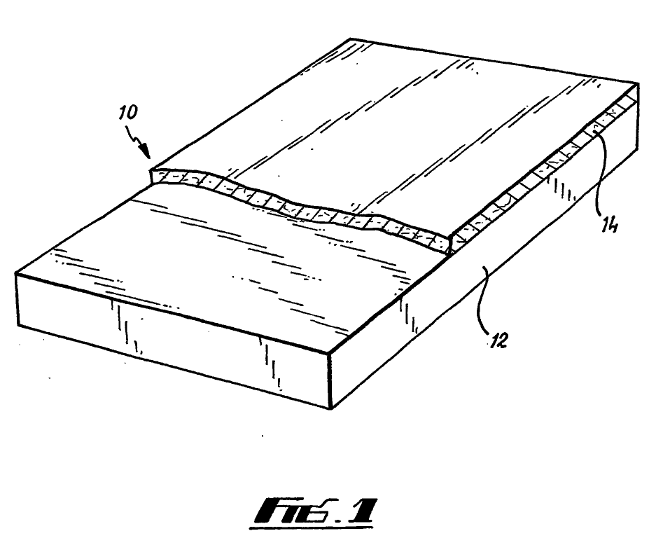

FIG. 1 is a perspective view of a pre-formed flashing material according to an embodiment of the present invention;

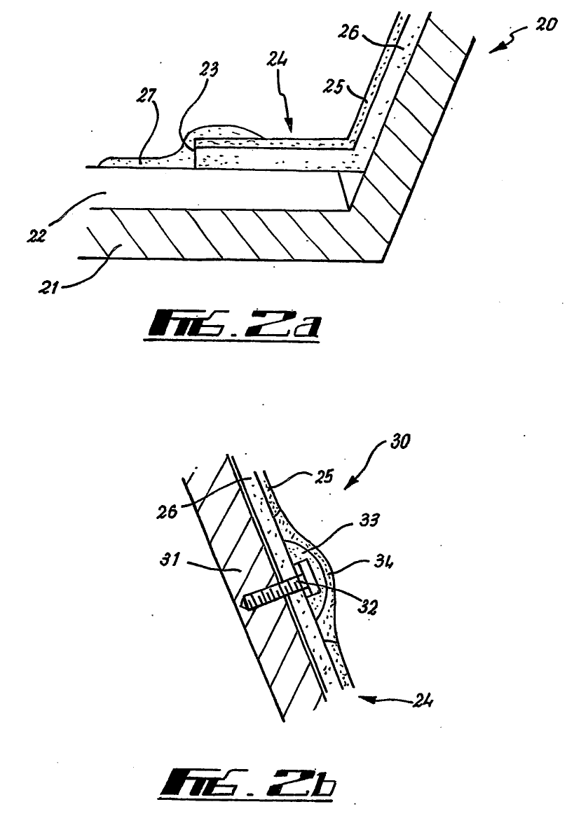

FIG. 2a shows a cross-sectional view of an example application of a lead sheet material and coating as a flashing;

FIG. 2b shows a cross-sectional view of an example application of a retroactively applied coating.

According to FIG. 1, there is shown a flashing material in sheet form, generally depicted at 10. The flashing material comprises a lead layer 12 and a leach-preventative coating 14. The leach-preventative coating 14 comprises a layer of a solid film lubricant. Solid film lubricants are suitable since they are non-toxic and inert.

In this example, the leach-preventative coating 14 comprises a mixture of an acrylic-based polymer and an epoxy-based polymer, and is cured exposure to ultraviolet (UV) light. The leach-preventative coating 14 has a thickness of up to approximately 300 microns. In this example, the leach-preventative coating 14 contains Polytetrafluoroethylene (PTFE) in a quantity of 0.1% to 2% dry weight on dry polymer to reduce scratching and abrasion. Molybdenum disulphide may be present in similar quantities as an alternative to PTFE.

The solid film lubricant is non-brittle, and is selected as having a softness greater than that of the lead layer. The layer is thus resiliently deformable, which allows the flashing material to be worked and formed into the required shape at the building construction without the coating cracking or flaking away from the lead layer. The degree of malleability required depends on the properties of the base layer itself. The relative proportions of acrylic and epoxy based polymers are selected in order to get an appropriate hardness and malleability of the resulting layer.

Although a material softer than lead is preferred, a material with a comparable softness, or even a slightly harder material would also suitable.

The leach-preventative coating 14 is blended with an abhorrent material for deterring pests from attacking the coating. The abhorrent is, in this example, extract of habanero pepper. The abhorrent is provided because the solid film layers used to coat the lead sheet are be subject to attack by various pests during manufacture and when fitted on exposed structures. Such pests include small mammals such as rats, mice, and squirrels, as well as invertebrate species such as roaches, termites, spiders, ants, and other insects. These species are liable to attack the coating on the lead layer, causing defect to it and re-exposing the lead layer to the environment. Attack by pests in sufficient quantities would negate the effect of a coating, and the lead layer would then be liable to leach into the environment after installation.

The leach-preventative coating 14 is blended with a photoinitiator for the initiation of a radical chain reaction, in order to facilitates the polymerisation process (described in more detail below).

The photoinitiator may be of the cationic photoinitiator type such as (but not limited to): diazonium salts, diaryliodium salts, triarylsulphonium salts, ferrocenium salts, dialkylphenacylsulphonium salts, sulphonyloxyketones or silylbenzylethers.

The photoinitiator may be of the radical photoinitiator type such as (but not limited to): alkylarylketones (acetophenone, benzophenone and derivatives thereof), diarylketones, benzoine, benzoine ethers, benzoineketals, benzilketals, acylphosphine oxide, thioxanthones and titanocenes.

A variety of known techniques are suitable for applying the solid film layer to the lead base layer. These include spraying, immersion (including dip-drain and dip-spin), curtain coating, electrophoresis, roller coating, printing, and application by brush. During storage and application of the coating, the formulation is protected from direct sunlight in order to prevent undesired polymerisation.

The coating is subsequently cured by UV curing.

The presence of a photoinitiator begins a radical chain reaction, although once commenced the polymerisation may proceed without any further contribution from the photoinitiator. The curing may take place in an inert atmosphere, or a low oxygen atmosphere in order to mitigate the effects of ambient oxygen on the un saturated bonds in the curable polymer which can result in longer curing time or insufficient curing. Typically, the reaction may tolerate an oxygen content of up to 3%. However, higher oxygen levels can be accounted for by adjusting the quantities or type of photoinitiator in the mixture.

Specifically, UV radical photoinitiators may be used in an inert atmosphere, and UV cationic photoinitiators may be used in an inert or oxygen-containing atmosphere.

The UV light may be supplied by any suitable light source emitting UV light, such as a mercury arc lamp. For example, the light source, may be a lamp restricted to wavelengths between 200 nanometres and 320 nanometres.

In alternative embodiments, the light source may be a lamp that emits light with wavelengths between 200 nanometres and 1.3 micrometres incorporating UV light, visible light and infrared light. Filters are used to prevent the UV light from exposing the environment around the reaction chamber.

In some cases, the coating may also be provided with UV absorbers to increase the sunlight resistance of the coating. During curing, these UV absorbers will compete with the polymerisation process to reduce the curing effects, but can be compensated for by longer curing time or by including compensatory photoinitiators.

It is possible to combine the abhorrent material into the coating layer before or after the layer has been applied to the lead base layer. For example, the abhorrent could be mixed with the coating material prior to coating and curing. Alternatively, the abhorrent could be sprayed or scattered on the coating layer after it has been applied but before curing.

FIG. 2a shows a typical application of an embodiment of the present invention. FIG. 2a shows a structure, generally depicted at 20, comprising roofing members 21, and an exposed planar member 22. The exposed planar member 22 is for example a roofing tile fitted to the structure 20.

Also fitted to the structure is a flashing 24, retrofitted to the structure 20 to improve waterproofing. The flashing 24 is a pre-formed sheet of flashing material as shown in FIG. 1, having a base lead layer 26 and a leach-preventative coating 25. The leach-preventative coating is a UV-cured polymer blended with an abhorrent for deterring pests. The flashing 24 is fitted such that it partially overlaps the tile 22.

At the seam 23, the two flashings are joined to one another by techniques known in the art. Subsequently, a layer 27 of the leach-preventative coating material is provided over the seam 23 to cover the exposed edge of the lead layer. The layer 27 is a thermoset polymer material blended with an abhorrent, such as extract of habanero pepper, and is applied to the seam 23 by spraying. When cured, the layer 27 forms a leach-preventative layer over the seam 23.

The coating 27 could alternatively be applied over the surface of the exposed planar member 22. For instance, if the planar member 22 is an existing lead flashing, the coating may be required over its entire exposed surface to prevent leaching and oxidising.

The coating of the present invention can equally be applied to soldered or welded regions of lead flashings. FIG. 2b shows an example of a structure, generally depicted at 30, to which a flashing layer 24 has been applied. The flashing layer 24 is of the type shown in FIG. 1, and comprises a lead base layer 26 and a leach-preventative coating 25. As before, the leach-preventative coating 25 is optionally provided with an abhorrent material.

The flashing 24 is secured to a roofing member by a screw 32 extending through the flashing sheet material and into the roofing member. The screw head is then provided with a lead covering 33, to prevent water penetration via the screw bore. The seal is made by soldering or welding the lead layer to the flashing 24. This application of heat causes damage to the leach-preventative coating 25, and results in an area of the lead base layer 26 surrounding the screw head to be exposed. A supplementary layer 34 of the leach-preventative coating is therefore provided over the lead layer 33.

In an alternative arrangement to that shown in FIG. 2b, the lead sheet material may be folded over and around the screw head, to avoid or reduce the requirement for soldering. The coating layer can be applied in the same way to prevent exposure of the lead to the environment.

It will be appreciated that the coating layer of the present invention has numerous applications in connection with flashings, roofing, and lead sheet materials.

For example, the lead sheet materials used in constructing flashings can be pre-formed with the leach-preventative coating, in the manner described with reference to FIG. 1. These pre-formed sheets can then be used for flashings for new construction projects, or retrofitted on pre-existing structures.

In addition, the nature of the coating allows is to be retrofitted to flashings in situ. This maybe, for example, at particular seams or joins in existing flashing materials, or over the entire roof or exposed surface of lead materials present on structures.

Furthermore, any new application of lead to existing structures, such as in patch repairs or soldering and welding operations may be coated with the leach preventative coating according to the present invention. This also applies to operations and activities that cause re-exposure of lead that has been previously coated with any coating material.

The arrangements shown in FIGS. 2a and 2b are exemplary only, and it will be apparent that many other applications of the sheeting material exist. For example, the lead sheet materials can be used for forming the base and sidewalls of a guttering channel.

Various modifications and changes could be made to the described embodiments within the scope of the claims. For example, the abhorrent material could be any natural or synthetic material or additive having a taste, odour or flavour repellent to pests. Examples include spices, oils, chemicals, clove oil and soap.

The present invention provides an improved lead sheeting material that is cost efficient and flexible in its application.

1. A sheet material comprising a lead layer and a leach-preventative coating, wherein the leach-preventative coating comprises an ultra-violet cured non-brittle solid film layer.

2. The sheet material as claimed in claim 1 wherein leach-preventative coating comprises an acrylic based polymer.

3. The sheet material as claimed in claim 1 wherein the leach-preventative comprises an epoxy based polymer.

4. The sheet material as claimed in claim 1 wherein the leach-preventative coating may comprise a mixture of an acrylic based polymer and an epoxy based polymer.

5. The sheet material as claimed in claim 1 wherein the leach-preventative coating comprises a material having a softness greater than that of lead.

6. The sheet material as claimed in claim 1 wherein the leach-preventative coating comprises polytetrafluoroethylene (PTFE).

7. The sheet material as claimed in claim 1 wherein the leach-preventative coating comprises molybdenum disulphide.

8. The sheet material as claimed in claim 1 wherein the leach-preventative coating has a thickness of 2 to 300 microns.

9. The sheet material as claimed in claim 1 wherein the leach-preventative coating comprises a photoinitiator for the initiation of a radical chain reaction.

10. The sheet material as claimed in claim 1 wherein the leach-preventative coating further comprises an abhorrent material for deterring pests from attacking said leach-preventative coating.

11. The sheet material as claimed in claim 10 wherein the abhorrent material includes chilli or chilli pepper.

12. The sheet material as claimed in claim 11 wherein the abhorrent material includes extract of habanero pepper.

13-14. (canceled)

15. A leach-preventative coating for a sheet material having a lead layer, the leach-preventative coating comprising an ultra-violet (UV) cured non-brittle solid film layer.

16. A method of preventing leaching of a flashing material having a lead layer, the method comprising the steps of applying an ultra-violet curable coating having a non-brittle solid film layer to a lead base layer, and UV curing the applied coating.

17. The method as claimed in claim 16 wherein the coating comprises a solid film lubricant layer.

18. The method as claimed in claim 16 wherein the coating is applied by a dipping process.

19. The method as claimed in claim 16 wherein the coating is applied by a spraying process.

20. The method as claimed in claim 16 wherein the coating is applied by a barrel process.

21. The method as claimed in claim 16 wherein the coating is applied by a brushing process.

22. The method as claimed in claim 16 wherein the lead base layer is part of a construction or building.
